(19) United States
(12) Patent Application Publication
(10) Pub. No.: US 2006/0269466 A1
(43) Pub. Date: Nov. 30, 2006

(54) Method for manufacturing carbonaceous nanofibers

(75) Inventors: Shu-Jiuan Huang, Taipei City (TW); Wen-Chuan Shu, Sinpu Township (TW); Chiou-Hwang Lee, Hsinchu City (TW); Tzong-Shyan Lu, Houlong Township (TW); Yi-Ming Chang, Hsinchu City (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu (TW)

(21) Appl. No.: 11/439,280

(22) Filed: May 24, 2006

(30) Foreign Application Priority Data
May 27, 2005 (TW) 094117409

(51) Int. Cl. C01B 31/02

(52) U.S. Cl. 423/445 B

(57) ABSTRACT

The present invention relates to a method for manufacturing carbonaceous nanofibers. The method comprises the following steps: (a) a liquid feed, a carrier gas and a de-coke agent are added into a reactor thereby to form a mixture, wherein the liquid feed includes a hydrocarbon, a catalyst precursor and a sulfide, and the carrier gas includes hydrogen; and (b) the mixture is heated at a temperature ranging from 700 to 1600° C. In this method, the hydrocarbon is used as a carbon source for the carbon material, which forms the carbonaceous nanofibers, a transition metal compound is used as a catalyst precursor, a sulfide is used as an auxiliary catalyst, and water or alcohol is used as a de-coke agent.

### BACKGROUND OF THE INVENTION

1. Field of the Invention

The present invention relates to a method for manufacturing carbonaceous nanofibers and, more particularly, to a continuous method for manufacturing carbonaceous nanofibers.

2. Description of Related Art

Carbonaceous nanofiber is one of the materials for the use of increasing conductivity such as in electromagnetic shelters and static electricity dissipation, and the electrodes of energy storage elements such as rechargeable lithium batteries, capacitors and fuel cells, absorption materials, catalyst carriers, and heat conducting materials. However, the output value and the production cost of the carbonaceous nanofibers are both costly. Therefore, economic benefits of reducing the production cost of the carbonaceous are being actively pursued.

Conventionally, the methods for manufacturing carbonaceous nanofibers include the arc-discharging method, the polymer-spinning method, substrate-grown chemical vapor deposition, and floated catalytic chemical vapor deposition. However, the arc-discharging method is excessively energy-consuming and the purity of the manufactured carbonaceous nanofibers is low. The steps of polymer-spinning method are complex. The production rate of the substrate-grown chemical vapor deposition is small because it is operated in a batch reactor. Hence, the carbonaceous nanofibers manufactured by the method according to the arc-discharging method, the polymer-spinning method, or substrate-grown chemical vapor deposition cannot be practically mass-produced.

Floated catalytic chemical vapor deposition is achieved by supplying a carbon source, a catalyst precursor, and a carrier gas into a reaction tube to form a mixture and then heating the mixture at a temperature about 1000° C. The catalyst precursor and the carbon source used in the method can be added into the reactor continuously. Moreover, the catalyst precursor and the carbon source are cheap and have high purity. Hence, floated catalytic chemical vapor deposition is the method that is practical for mass-production.

However, the by-products, such as amorphous carbon, easily adhere on the inner perimeter wall surface of the reaction tube and the manufactured carbonaceous nanofibers therefore are blocked inside the reaction tube. Thus, it is difficult to remove the manufactured carbonaceous nanofibers from the reaction tube. Besides, because of the problem that the nanofibers are blocked inside the reaction tube, the nanofibers cannot exit the reactor automatically and continuously so that the nanofibers cannot be mass-produced. Moreover, because the time that the mixture (or the nanofibers) spends in the reactor is not stable, the diameter of the nanofibers varies. As a result, the floated catalytic chemical vapor deposition is mostly a batch process or a semi-continuous process.

Therefore, it is desirable to provide an improved method for manufacturing carbonaceous nanofibers to mitigate and/or obviate the aforementioned problems.

### SUMMARY OF THE INVENTION

The present invention relates to a method for manufacturing carbonaceous nanofibers. The method comprises the following steps: (a) a liquid feed, a carrier gas and a de-coke agent are added into a reactor thereby to form a mixture, wherein the liquid feed includes a hydrocarbon, a catalyst precursor and a sulfide, and the carrier gas includes hydrogen; and (b) the mixture is heated at a temperature ranges from 700 to 1600° C. In this method, the hydrocarbon is used as a carbon source, which forms the carbonaceous nanofibers, and the sulfide is used as an auxiliary catalyst.

The method of the present invention is achieved through floated catalytic chemical vapor deposition. In other words, the present invention forms the carbonaceous nanofibers by supplying a liquid feed containing a carbon source, a catalyst precursor, and an auxiliary catalyst, a carrier gas, and a de-coke agent to a reactor maintained at a temperature of about 700 to 1600° C. Due to the participation of the de-coke agent in the reaction, the adhesion of by-products, such as amorphous carbon, on the inner perimeter wall surface of the reactor and on the surface of the catalyst particles is prevented. The by-product does not accumulate inside the reactor and the carbonaceous nanofibers therefore can exit the reactor continuously without being blocked inside the reactor.

The reaction that the de-coke agent reacts with amorphous carbon is represented by formula (I)
C+de-coke agent→CO/CO₂+H₂/H₂O (I)
Therefore, the by-product can be removed and decomposed by adding a de-coke agent such as water or alcohol. As a result, only carbonaceous nanofibers, i.e. crystal carbon, are formed in the reactor.

With the present invention, the problem of the conventional method that the carbonaceous nanofibers are blocked in the reactor is solved. Moreover, the problem of the conventional method that it is difficult for the nanofibers to be taken out from the reactor is solved because the product can exit the reactor continuously. Besides, due to the variety of the adjustable conditions, such as the concentration of hydrogen, the molar ratio of reactant to catalyst, or the time that the mixture (or product) spends in the reactor etc., the diameter of the carbonaceous nanofibers can be controlled effectively through appropriate regulating of the aforementioned conditions. Furthermore, the carbonaceous nanofibers with uniform diameter can be obtained because the time that the product spends in the reactor is stable. As a result, the carbonaceous nanofibers can be mass-produced and the cost of manufacturing carbonaceous nanofibers can be reduced.

The carbon source used in the method for manufacturing carbonaceous nanfiobers of the present invention can be any conventional hydrocarbon suitable to use as a carbon source of vapor grown carbon fibers. Preferably, the hydrocarbon is aromatic hydrocarbon, such as benzene, toluene, xylene, naphthalene, anthracene or cyclohexane; aliphatic hydrocarbon, such as methane, ethane, propane, butane, heptane, hexane, ethylene, or acetylene; hydrocarbon containing at least one oxygen atom, such as ethanol, methanol, propanol, or furan; hydrocarbon containing at least one nitrogen atom, such as amine or pyridine; or other hydrocarbons, such as gasoline or gas oil. More preferably, the hydrocarbon is benzene, xylene, toluene, ethanol, methanol, propanol, hexane, or cylcohexane. The catalyst precursor used in the method for manufacturing carbonaceous nanofibers of the present invention can be any conventional transition metal compound suitable to use as a catalyst precursor of vapor grown carbon fibers. Preferably, the transition metal compound is an organic transition metal compound, such as ferrocene, nickelocene, cobaltcene, cobalt (II) acetylacetonate, iron carbonyl, iron acetylacetonate, or iron oleate; or inorganic transition metal compound, such as iron chloride. More preferably, the transition metal compound is ferrocene, nickelocene, or cobalt (II) acetylacetonate. The auxiliary catalyst used in the method for manufacturing carbonaceous nanofibers of the present invention can be any sulfide. Preferably, the sulfide is heterocyclic sulfide, such as thiophene, thianaphthene, or benzothiophene; or inorganic sulfide, such as hydrogen sulfide. More preferably, the sulfide is thiophene.

Besides, the carrier gas used in the method for manufacturing carbonaceous nanofibers of the present invention can further comprise an inert gas. The inert gas can be any conventional inert gas. Preferably, the inert gas is nitrogen, argon, or helium. The de-coke agent used in the method for manufacturing carbonaceous nanofibers of the present invention can be any conventional compound used to remove or decompose amorphous carbon. Preferably, the de-coke agent is water or alcohol, such as methanol, ethanol, or propanol. The way to bring the de-coke agent into the reactor is not limited. Preferably, the de-coke agent is brought in by adding to the liquid feed or adding to the carrier gas through a bubbler.

In addition, high purity and high selectivity carbonaceous nanofibers can be obtained by appropriately regulating the reaction condition. Preferably, the volume percentage of the de-coke agent ranges from 5 ppm to 2% of the mixture. More preferably, the volume percentage of the de-coke agent ranges from 10 ppm to 1% of the mixture. Preferably, the weight percentage of the catalyst precursor ranges from 0.1 to 25 wt % of the liquid feed. More preferably, the weight percentage of the catalyst precursor ranges from 0.3 to 20 wt % of the liquid feed. Preferably, the weight percentage of the sulfide ranges from 0.01 to 8 wt % of the liquid feed. More preferably, the weight percentage of the sulfide ranges from 0.02 to 5 wt % of the liquid feed. Preferably, the volume percentage of the hydrogen ranges from 8% to 100% of the carrier gas. More preferably, the volume percentage of the hydrogen ranges from 10 to 100% of the carrier gas. Also, the temperature for heating the mixture in step (b) of the present invention preferably ranges from 800 to 1400° C. More preferably, the temperature ranges from 900 to 1300° C. Furthermore, the diameters of the carbonaceous nanofibers can also be controlled by regulating the time that the mixture (or nanofibers) spends in the reactor. Therefore, the time that the mixture (or nanofibers) spends in the reactor is not limited. Preferably, the time ranges from 0.5 to 3 minutes. Thus, the diameter of the carbonaceous nanofibers manufactured through the method of the present invention is not limited. Preferably, the diameter of the carbonaceous nanofibers ranges from 1 nm to 1 μm.

Other objects, advantages, and novel features of the invention will become more apparent from the following detailed description when taken in conjunction with the accompanying drawings.

### BRIEF DESCRIPTION OF THE DRAWINGS

FIG. 1 shows a schematic diagram of a reaction system used for the manufacturing method of the carbonaceous nanofibers according to Embodiment 1 of the present invention;

FIG. 2(a) shows a picture of the carbonaceous nanofibers collected by the fiber collector according to Embodiment 1 of the present invention;

FIG. 2(b) shows a scanning electron microscopy image of the carbonaceous nanofibers manufactured according to Embodiment 1 of the present invention;

FIG. 3(a) shows a picture of the carbonaceous nanofibers collected by the fiber collector according to a conventional method;

FIG. 3(b) shows a scanning electron microscopy image of the carbonaceous nanofibers manufactured according to conventional method;

FIG. 4 shows a scanning electron microscopy image of the carbonaceous nanofibers manufactured according to Embodiment 2 of the present invention;

FIG. 5 shows a scanning electron microscopy image of the carbonaceous nanofibers manufactured according to Embodiment 3 of the present invention;

FIG. 6 shows a scanning electron microscopy image of the carbonaceous nanofibers manufactured according to Embodiment 4 of the present invention;

FIG. 7 shows a scanning electron microscopy image of the carbonaceous nanofibers manufactured according to Embodiment 5 of the present invention; and

FIG. 8 shows a scanning electron microscopy image of the carbonaceous nanofibers manufactured according to Embodiment 6 of the present invention.

### DETAILED DESCRIPTION OF THE PREFERRED EMBODIMENT

The embodiments of the present invention are achieved through floated catalytic chemical vapor deposition. In the present embodiment, the liquid feed comprises a carbon source, a catalyst precursor and an auxiliary precursor, wherein the carbon source can be any conventional hydrocarbon, such as benzene, xylene, toluene, ethanol or methanol, the catalyst precursor can be any transition metal compound, such as ferrocene, the auxiliary catalyst can be any sulfide, such as thiophene. Besides, the liquid feed is supplied into a reactor at a fixed flow rate through a liquid transferring system. The carrier gas comprises hydrogen and an inert gas, such as nitrogen, argon or helium. Water or alcohol can be the de-coke agent of the present embodiment, and can also be supplied to the reactor through a liquid transferring system or through a bubbler.

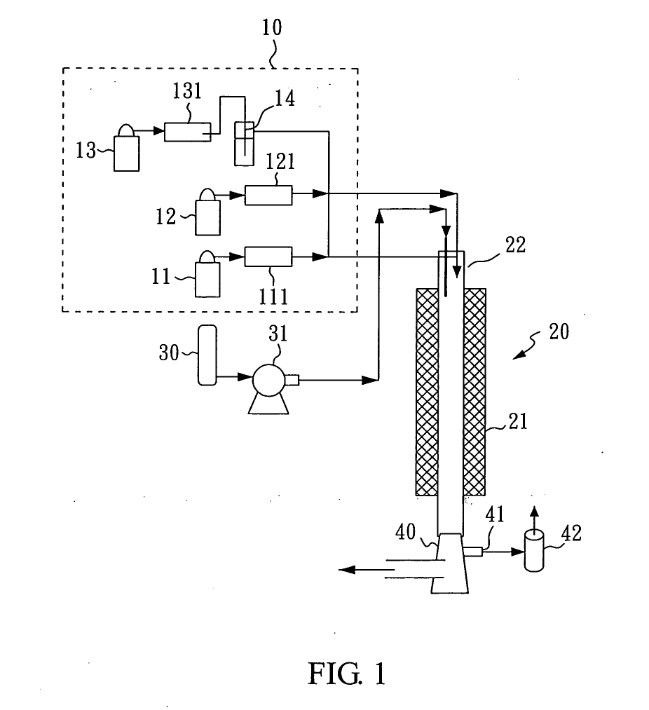

FIG. 1 shows a reaction system used for the manufacturing method of the carbonaceous nanofibers of the present embodiment. The reaction system includes a gas feed unit 10, which has a hydrogen vessel 11, a first argon vessel 12, a second argon vessel 13, and a de-coke agent tank 14. Therefore, argon sent from the second argon vessel 13 to the reactor 20 contacts the de-coke agent stored in the de-coke agent tank 14 and carries some of the de-coke agent to the reactor 20. In other words, in the embodiment, the de-coke agent, such as water, is supplied to the reactor through a bubbler. Besides, the flow rate of the above gas can be controlled by mass flow control 111,121,131.

The liquid feed is stored in the liquid feed tank 30. The liquid feed is supplied by a pump 31 to a reactor 20 via pipes. The temperature at the entry 22 of the reactor 20 is controlled and maintained higher than the boiling point of the liquid feed so that the liquid feed is vaporized before entering the reactor 20. Otherwise, a sprayer or a pre-heater can also used to vaporize the liquid feed before entering the reactor 20.

In addition, a heater 21 is fitted on the reactor 20. Therefore, the temperature inside the reactor 20 is controlled by the heater 21 and maintained at 900 to 1300° C. A fiber collection 40 is connected to the lower end of the reactor 20 so as to collect the manufactured carbonaceous nanofibers that exit from the reactor 20. The fiber collection 40 has a gas exhausting opening 41 and the gas exhausting opening 41 is further connected to a cooling tank 42. Therefore, the carrier gas supplied to the reactor 20 from the carrier gas unit 10 can exhaust to the atmosphere via the cooling tank 42 and be cooled to room temperature.

In the present embodiment, the weight percentage of the transition metal compound ranges from 0.1 to 20 wt % of the liquid feed. The weight percentage of the sulfide ranges from 0.05 to 10 wt % of the liquid feed. The volume percentage of the hydrogen ranges from 10 to 100% of the carrier gas. The volume percentage of the de-coke agent ranges from 10 ppm to 1% of the mixture of the liquid feed, the carrier gas and the de-coke agent in the reactor. Besides, the time that the mixture spends in the reactor ranges from 0.5 to 3 seconds.

### Embodiment 1

The manufacture of the carbonaceous nanofibers of the present embodiment is conducted using the reaction system shown in FIG. 1. The liquid feed comprises benzene, ferrocene and thiophene with a mixing ratio of 100:1:0.5 by weight. The carrier gas comprises hydrogen, argon and water (i.e. decoke agent) with a mixing ratio of 45:55:5×10⁻⁴ by volume. The liquid feed and the carrier gas enter the entry 22 of the reactor 20 at a temperature of 250° C. The mixture that is composed of the liquid feed and the carrier gas (comprising de-coke agent) is heated at a temperature approximately 1150° C. The time that the mixture spends in the reactor is approximately 60 seconds.

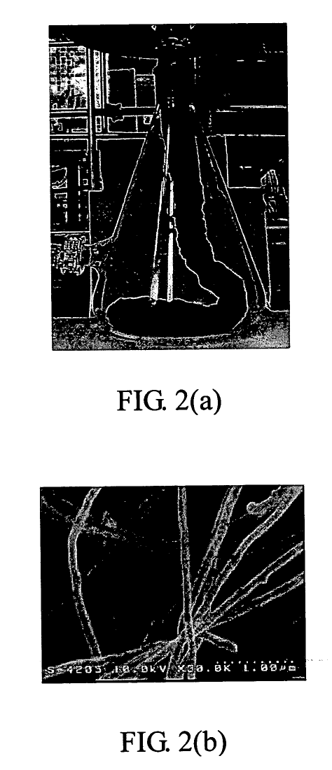

FIG. 2(a) shows the picture of the carbonaceous nanofibers collected by the fiber collector. From this picture, it can be confirmed that the carbonaceous nanofibers can exit the lower end of the reactor continuously rather than being blocked in the reactor. FIG. 2(b) shows the scanning electron microscopy (SEM) image of the carbonaceous nanofibers manufactured in the present embodiment. From this SEM image, the manufactured carbonaceous nanofibers are shown to have the same diameters of approximately 150 nm.

### Comparative Embodiment 1

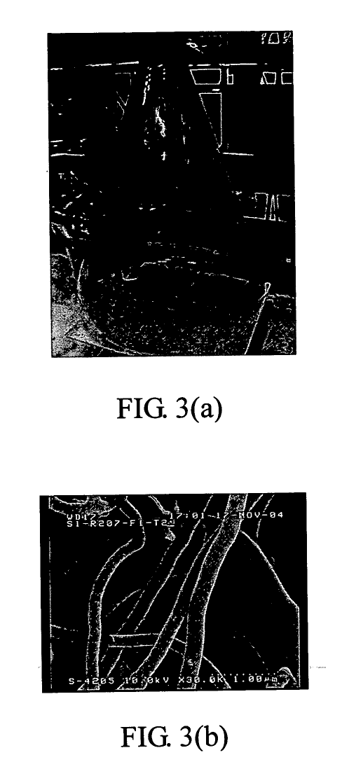

The reaction conditions of the present embodiment are identical to those disclosed in Embodiment 1 except for the adding of water (i.e. de-coke agent). FIG. 3(a) shows the picture of the carbonaceous nanofibers collected by the fiber collector. From this picture, it can be confirmed that the carbonaceous nanofibers cannot exit the lower end of the reactor continuously but instead are blocked in the reactor. Therefore, it is necessary to stop the reaction occurring in the reactor before taking out the carbonaceous nanofibers from the reactor. Usually, the reaction is maintained for five minutes. FIG. 3(b) shows the SEM image of the carbonaceous nanofibers manufactured in the present comparative embodiment. From this SEM image, the manufactured carbonaceous nanofibers are shown to have various diameters.

### Embodiment 2

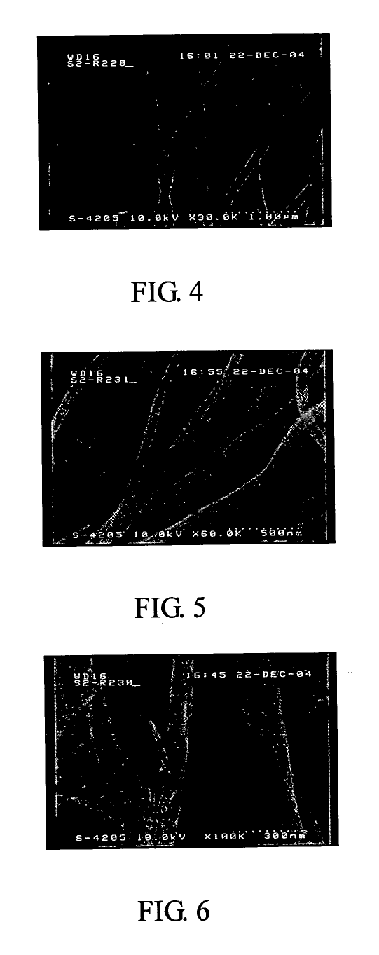

The reaction conditions of the present embodiment are identical to those disclosed in Embodiment 1 except for the carrier gas of hydrogen, argon and water with a mixing ratio of a volume ratio of 45:55:56×10⁻⁴ and the time that the mixture spends in the reactor is 40 seconds. The carbonaceous nanofibers can exit the lower end of the reactor continuously and the carbonaceous nanofibers therefore are shown to have the same diameters of approximately 120 nm (see FIG. 4).

### Embodiment 3

The reaction conditions of the present embodiment are identical to those disclosed in Embodiment 1 except for the time that the mixture spends in the reactor is 20 seconds. The carbonaceous nanofibers can exit the lower end of the reactor continuously and the carbonaceous nanofibers therefore are shown to have the same diameters of approximately 60 nm (see FIG. 5).

### Embodiment 4

The reaction conditions of the present embodiment are identical to those disclosed in Embodiment 1 except for the time that the mixture spends in the reactor is 10 seconds. The carbonaceous nanofibers can exit the lower end of the reactor continuously and the carbonaceous nanofibers therefore are shown to have the same diameters of approximately 30 nm (see FIG. 6).

### Embodiment 5

The reaction system used for manufacturing of the carbonaceous nanofibers of the present embodiment is identical to that disclosed in Embodiment 1 except for the present inclusion of the second argon vessel 13, the de-coke agent tank 14 and the mass flow controller 131. Hence, the de-coke agent is stored in the liquid feed tank 30 and brought into the reactor 20 from the liquid feed tank 30.

The liquid feed stored in the liquid feed tank 30 comprises benzene, anhydrous alcohol (i.e the de-coke agent), ferrocene and thiophene with a mixing ratio of a weight ratio of 75:25:1:0.5. The carrier gas comprises hydrogen and argon with a mixing ratio of a volume ratio of 30:70. The liquid feed and the carrier gas pass through the entry of the reactor at a temperature of 250° C. The mixture that is composed of the liquid feed and the carrier gas is heated to a temperature (i.e. the reaction temperature) of approximately 1150° C. Besides, the time that the mixture spends in the reactor is approximately 60 seconds.

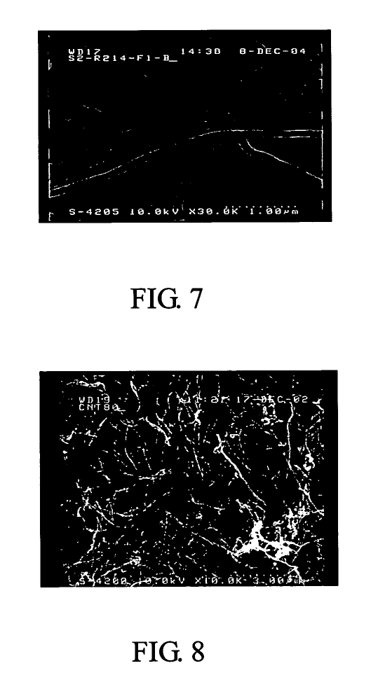

The carbonaceous nanofibers can exit the lower end of the reactor continuously and the carbonaceous nanofibers therefore are shown to have the same diameters of approximately 150 nm (see FIG. 7).

### Embodiment 6

The reaction system used for manufacturing of the carbonaceous nanofibers of the present embodiment is identical to that disclosed in Embodiment 5.

The liquid feed stored in the liquid feed tank 30 comprises anhydrous alcohol and cobalt(II) acetylacetonate with a mixing ratio of a weight ratio of 100:0.5. The carrier gas comprises hydrogen and argon with a mixing ratio of a volume ratio of 40:60. The liquid feed and the carrier gas pass through the entry of the reactor at a temperature of 250° C. The mixture that is composed of the liquid feed and the carrier gas is heated to a temperature (i.e. the reaction temperature) of approximately 1150° C. Besides, the time that the mixture spends in the reactor is approximately 60 seconds.

The carbonaceous nanofibers can exit the lower end of the reactor continuously and the carbonaceous nanofibers therefore are shown to have the same diameters around 60 nm (see FIG. 8).

Due to the participation of the de-coke agent in the reaction, the adhesion of by-products, such as amorphous carbon, on the inner perimeter wall surface of the reactor and on the surface of the catalyst particles is prevented. Hence, the by-product does not accumulate inside the reactor and the carbonaceous nanofibers therefore can exit the reactor continuously without being blocked in the reactor. As a result, the carbonaceous nanofibers can be mass produced and the cost of manufacturing carbonaceous nanofibers can be reduced relative to the prior art.

Furthermore, the carbonaceous nanofibers with uniform diameter can be obtained because the time that the mixture (or the product) spends in the reactor is stable (see FIG. 2(a)). Thus, the diameters of the manufactured carbonaceous nanofibers can be effectively controlled through appropriately regulating of the adjustable conditions, such as the concentration of hydrogen or the molar ratio of reactant to catalyst, at a fixed time that the mixture (or the product) spends in the reactor. On the contrary, the carbonaceous nanofibers manufactured in the conventional method are blocked in the reactor. Therefore, the time that the mixture (or the product) spends in the prior art reactor is unstable. As a result, the obtained prior art nanofibers have various diameters (see FIG. 2(b)).

Although the present invention has been explained in relation to its preferred embodiment, it is to be understood that many other possible modifications and variations can be made without departing from the scope of the invention as hereinafter claimed.

What is claimed is:

1. A method for manufacturing carbonaceous nanofibers comprising the following steps:
(a) adding a liquid feed, a carrier gas and a de-coke agent into a reactor thereby to form a mixture, wherein the liquid feed includes a hydrocarbon, a catalyst precursor and a sulfide, and the carrier gas includes hydrogen; and
(b) heating the mixture to a temperature ranging from 700 to 1600° C.

2. The method as claimed in claim 1, wherein the de-coke agent is water or alcohol.

3. The method as claimed in claim 1, wherein the catalyst precursor is a transition metal compound.

4. The method as claimed in claim 1, wherein the carrier gas includes an inert gas.

5. The method as claimed in claim 4, wherein the inert gas is nitrogen, argon or helium.

6. The method as claimed in claim 1, wherein the sulfide is heterocyclic sulfide.

7. The method as claimed in claim 1, wherein the sulfide is inorganic sulfide.

8. The method as claimed in claim 3, wherein the transition metal compound is ferrocene or cobalt (II) acetylacetonate.

9. The method as claimed in claim 1, wherein the hydrocarbon is benzene, xylene, ethanol, methanol, propanol, hexane or cylcohexane.

10. The method as claimed in claim 2, wherein the alcohol is methanol, ethanol or propanol.

11. The method as claimed in claim 1, wherein the volume percentage of the de-coke agent ranges from 10 ppm to 1% of the mixture.

12. The method as claimed in claim 1, wherein the weight percentage of the catalyst precursor ranges from 0.3 to 20 wt % of the liquid feed.

13. The method as claimed in claim 1, wherein the weight percentage of the sulfide ranges from 0.02 to 5 wt % of the liquid feed.

14. The method as claimed in claim 4, wherein the volume percentage of the hydrogen ranges from 10% to 100% of the carrier gas.

15. The method as claimed in claim 1, wherein the time that the mixture spends in the reactor ranges from 30 seconds to 3 minutes.

16. The method as claimed in claim 1, wherein the diameter of the carbonaceous nanofibers ranges from 1 nm to 1 μm.
